(19) United States
(12) Patent Application Publication
(10) Pub. No.: US 2024/0227285 A1
(43) Pub. Date: Jul. 11, 2024

(54) MULTI-POLYMER SYSTEMS FOR ADDITIVE MANUFACTURING

(71) Applicant: OPT Industries, Inc., Medford, MA (US)

(72) Inventors: James Shin, Sharon, MA (US); Kai-Hong Anthony Chu, Cambridge, MA (US)

(73) Assignee: OPT Industries, Inc., Medford, MA (US)

(21) Appl. No.: 18/559,335

(22) PCT Filed: May 27, 2022
(86) PCT No.: PCT/US2022/031244

§ 371 Date: Nov. 6, 2023

Related U.S. Application Data
(60) Provisional application No. 63/194,831, filed on May 28, 2021.

(51) Int. Cl. B29C 64/188; B33Y 40/20; C08J 7/04; C09D 175/04

(52) U.S. Cl. CPC B29C 64/188; B33Y 40/20; C08J 7/0427; C09D 175/04; C08J 2323/00; C08J 2475/04

(57) ABSTRACT

The methods is provided for 3D-printing a polymeric scaffold which can have a large cross-sectional area, but can be porous, such that the printed portion of the scaffold has features with dimensions that allow rapid resin recoating without the mechanical assistance of a recoating blade. This 3D-printed scaffold can then be immersed in a polymeric precursor (e.g., comprising monomers and/or oligomers) that flows into and is retained in the scaffold. Excess polymeric precursor can be removed (e.g., washed) from the exterior of the scaffold. The entrained polymeric precursor can then be polymerized to create a polymeric object. The polymeric object can have a large cross-sectional area, a high bulk density, and other desirable properties. The other properties can be achieved by having two intertwined but not homogenously mixed polymers that each have their individual properties, but work to impart desirable properties on the polymeric object as a whole.

### RELATED APPLICATIONS

This Application claims priority to pending U.S. Patent Application Ser. No. 63/194,831, filed May 28, 2021, entitled “MULTI-POLYMER SYSTEMS FOR ADDITIVE MANUFACTURING”, which is hereby incorporated herein by reference in its entirety.

### NOTICE OF MATERIAL SUBJECT TO COPYRIGHT PROTECTION

Portions of the material in this patent document are subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND

Additive manufacturing technology, also known as 3D printing, allows for the manufacture of finished products with complex geometries that are difficult or impossible to make with other technologies. High-resolution stereolithography 3D printing, specifically Digital Light Processing (DLP) printing technology, can allow printing resolutions of less than 100 micrometers (um). High-resolution 3D printing allows one to produce intricate structures to reduce object weight, construct metamaterials, realize biomimicry design or simply achieve aesthetic surface textures.

### SUMMARY

Although the resolution of recent 3D printers has been improving, it is appreciated that some applications can be limited by inadequate properties of the polymeric object being printed using prior methods. For example, printing of UV-curable polymers can be slower, on an overall volumetric basis, than volumetric polymerization chemistries. Therefore, printing of large cross sections can be both slower, and introduce complications with regard to resin needing to flow over and recoat a larger area between successive printed layers.

The systems and methods described herein address some of the aforementioned technical problems associated with 3D printing. The methods can include 3D-printing a polymeric scaffold which can have a large cross-sectional area, but can be porous, such that the printed portion of the scaffold has features with dimensions that allow rapid resin recoating without the mechanical assistance of a recoating blade. This 3D-printed scaffold can then be immersed in a polymeric precursor (e.g., comprising monomers and/or oligomers) that flows into and is retained in the scaffold. Excess polymeric precursor can be removed (e.g., washed) from the exterior of the scaffold. The entrained polymeric precursor can then be polymerized to create a polymeric object. The polymeric object can have a large cross-sectional area, a high bulk density, and other desirable properties. The other properties can be achieved by having two intertwined but not homogenously mixed polymers that each have their individual properties, but work to impart desirable properties on the polymeric object as a whole.

Without limitation, the systems and methods described herein can print polymeric objects that have superior properties, including a tunable bulk density. In some cases, the polymeric object has an anisotropic property (i.e., a property that is different when measured across a different direction of the object).

Furthermore, the methods described herein can be used to print objects with large cross-sectional areas using a continuous top-down 3D printing architecture (e.g., without a mechanical recoating blade). A recoating blade that levels the resin between layers can prevent some prior methods from printing continuously. Removing the leveling blade can limit the print to small cross-sectional areas due to relying on gravity-assisted resin reflow to replenish resin into the area to be cured.

In an aspect, provided herein is a method for forming a polymeric object. The method can comprise providing a 3D-printed scaffold having a porous volume, wherein a surface of the scaffold is associated with a boundary of a desired shape; contacting the scaffold with a polymeric precursor such that the polymeric precursor flows into and is retained in the porous volume of the scaffold; and polymerizing the polymeric precursor that is retained in the porous volume.

In some embodiments, the porous volume is a 3D-printed lattice.

In some embodiments, the porous volume has a pore diameter between about 50 and about 1,000 micrometers.

In some embodiments, a pore diameter of the porous volume is selected such that the polymeric precursor is retained in the porous volume.

In some embodiments, a viscosity of the polymeric precursor is selected such that the polymeric precursor is retained in the porous volume.

In some embodiments, a viscosity of the polymeric precursor is between about 500 and about 10,000 centipoise.

In some embodiments, a composition of the polymeric precursor is selected such that the polymeric precursor has a suitable surface tension to be retained in the porous volume.

In some embodiments, the method further comprises washing polymeric precursor from the scaffold prior to polymerizing the polymeric precursor that is retained in the porous volume.

In some embodiments, the polymerized polymeric precursor forms covalent bonds with the scaffold.

In some embodiments, the polymerized polymeric precursor effectively fills the porous volume.

In some embodiments, contacting the scaffold with a polymeric precursor comprises submersing the scaffold in the polymeric precursor.

In some embodiments, a surface of the scaffold is functionalized to react with the polymeric precursor.

In some embodiments, the scaffold is made from a monomer having a plurality of ethylenically unsaturated moieties.

In some embodiments, the scaffold is made from a monomer having at least two reactive groups.

In some embodiments, the reactive groups are an ethynically unsaturated group and one or more of a hydroxy, epoxy, amine, isocyanate, silyl hydride, or carboxylic acid moiety. The method of claim 1, wherein the porous volume has a cross section of at least about 1 centimeter (cm).

In some embodiments, the polymeric precursor is capable of undergoing a free radical polymerization, polyaddition, or polycondensation reaction.

In some embodiments, the polymeric precursor has at least one group capable of undergoing free radical polymerization.

In some embodiments, the polymeric precursor comprises at least two reactive chemical groups capable of undergoing a polycondensation reaction.

In some embodiments, the reactive chemical groups capable of undergoing polycondensation comprise amine, epoxy, isocyanate, or any combination thereof. The method of claim 1, wherein the reactive chemical groups comprise a reactive pair selected from Isocyanate/amine, isocyanate/hydroxyl, isocyanate/carboxylic acid, epoxy/amine, epoxy/hydroxyl, epoxy/carboxylic acid, oxetane/amine, anhydride/amine, anhydride/hydroxyl, amine/carboxylic acid, amine/ester, hydroxyl/carboxylic acid, hydroxyl/acid chloride, amine/acid chloride, or any combination thereof.

In some embodiments, the polymeric precursor is an aqueous or organic dispersion.

In some embodiments, the aqueous or organic dispersion comprises a polyurethane.

In some embodiments, the polymeric precursor comprises at least two monomers, wherein a first monomer comprises at least two copies of a first reactive group, a second monomer comprises at least two copies of a second reactive group, and the first reactive group is capable of forming a covalent bond with the second reactive group.

In some embodiments, at least one of the reactive chemical groups is capable of forming a covalent bond with the scaffold.

In some embodiments, the polymeric precursor comprises a surfactant, thickening agent, thixotropic agent, or filler.

In some embodiments, a concentration of a surfactant, thickening agent, thixotropic agent, or filler is selected such that the polymeric precursor is retained in the porous volume.

In some embodiments, the polymeric precursor does not comprise monomers that form a vinyl network.

In some embodiments, the polymeric precursor is heated to a temperature sufficient for the polymeric precursor to flow into the porous volume.

In some embodiments, the polymeric precursor is cooled to a temperature sufficient for the polymeric precursor to be retained in the porous volume.

In some embodiments, the polymeric precursor is polymerized upon exposure to heat.

In some embodiments, the polymeric precursor is polymerized upon exposure to actinic radiation.

In some embodiments, the method further comprises contacting the 3D printed scaffold and/or the polymeric object with an electroless coating solution.

In some embodiments, the scaffold is 3D printed on a pliable substrate.

In some embodiments, the pliable substrate is moved through a vat of fluid that is polymerizable upon exposure to actinic radiation.

In another aspect, provided herein is a polymeric object, comprising: a polymeric scaffold comprising segments of a vinyl polymer which are interconnected at an average distance between about 50 and about 1,000 micrometers; and a polymeric material between the segments of vinyl polymer of the polymeric network.

In some embodiments, the polymeric scaffold is 3D-printed.

In some embodiments, the polymeric material is in contact with the segments of vinyl polymer of the polymeric scaffold.

In some embodiments, the polymeric material is covalently bonded to the segments of vinyl polymer of the polymeric scaffold.

In some embodiments, the polymeric object comprises a non-homogenous mixture comprising a vinyl polymer and the polymeric material.

In some embodiments, the polymeric scaffold at least partially surrounds the polymeric material.

In some embodiments, the polymeric object has an anisotropic property.

In some embodiments, the anisotropic property is young's modulus, thermal conductivity, electrical conductivity, or any combination thereof.

In some embodiments, the polymeric object has bulk density of at least about 0.8 g/cm³.

In some embodiments, the polymeric material comprises a polyurethane, epoxy, or thermoset polymer.

In another aspect, provided herein is a polymeric object produced by the methods described herein.

It should be appreciated that all combinations of the foregoing concepts and additional concepts discussed in greater detail below (provided such concepts are not mutually inconsistent) are contemplated as being part of the inventive subject matter disclosed herein. In particular, all combinations of subject matter within this disclosure are contemplated as being part of the inventive subject matter disclosed herein.

Still other aspects, examples, and advantages of these exemplary aspects and examples, are discussed in detail below. Moreover, it is to be understood that both the foregoing information and the following detailed description are merely illustrative examples of various aspects and examples and are intended to provide an overview or framework for understanding the nature and character of the claimed aspects and examples. Any example disclosed herein may be combined with any other example in any manner consistent with at least one of the objects, aims, and needs disclosed herein, and references to “an example,” “some examples,” “an alternate example,” “various examples,” “one example,” “at least one example,” “ this and other examples” or the like are not necessarily mutually exclusive and are intended to indicate that a particular feature, structure, or characteristic described in connection with the example may be included in at least one example. The appearances of such terms herein are not necessarily all referring to the same example.

### FIGURES

FIG. 1A shows an example of a cross sectional area of a 3D printed scaffold.

FIG. 1B shows an example of a 3D printed scaffold immersed in a polymeric precursor.

FIG. 1C shows an example of a polymeric precursor retained in a porous volume of a 3D printed scaffold.

FIG. 1D shows an example of a polymeric object having a 3D printed scaffold comprising segments of a vinyl polymer and a polymeric material between the segments of the vinyl polymer.

FIG. 2A shows an example of a surface of a 3D printed scaffold in contact with a polymeric precursor.

FIG. 2B shows an example of a surface of a 3D printed scaffold covalently bonded with a polymeric material.

FIG. 3A shows an example of a pore of a 3D printed scaffold filled with a polymeric precursor.

FIG. 3B shows an example of a pore of a 3D printed scaffold filled with a polymeric material.

FIG. 4 shows an example of how the dimensions of the interstitial spaces between portions of the scaffold affect coating versus in-filling of the scaffold with the polymeric material.

FIG. 5 shows an example of a complex scaffold having portions that are coated with polymeric material and portions that are filled in with polymeric material.

FIG. 6 shows an example of a 3D printing system that utilizes a pliable substrate.

### DESCRIPTION

Materials for the additive manufacturing industry, commonly referred as 3D printing, can utilize a multitude of polymerization techniques to create 3D articles with desirable material performance properties for end-use applications.

Traditionally, UV curable formulations used in the additive manufacturing industry can include ethylenically (i.e., double bond) unsaturated oligomers and monomers (e.g., acrylates, methacrylates, vinyl ethers), diluents, photo-initiators, and additives. The oligomers and monomers can provide mechanical properties to the final product upon polymerization. Diluents can reduce overall formulation viscosity for ease of processing and handling. Diluents can be reactive and can be incorporated into the polymer matrix of the finished article. Photo-initiators can form free radicals upon exposure to actinic radiation (e.g., through photolytic degradation of the photo-initiator molecule). The free radicals can then utilize the ethylenically unsaturated chemical groups to form vinyl-based polymers. Additives can include but are not limited to pigments, dyes, UV absorbers, hindered amine light stabilizers, and fillers. Additives can be used to impart useful properties such as color, shelf stability, improved lifetime performance, higher UV stability, etc.

Prior resin-based additive manufacturing approaches generally utilize material formulations that contain all necessary components needed for polymerization and fabrication of the final part. The photopolymerizable portion of the formulation is typically composed of ethylenically unsaturated monomers and oligomers which polymerize upon exposure to actinic radiation through a free radical polymerization process to form vinyl-based polymer networks. Vinyl-based networks are known for having either a combination of high modulus and low elongation, or low modulus and high elongation. For end-use engineering applications, a combination of moderately high modulus and moderately high elongation can be desirable.

The materials and methods described herein can have photopolymerizable components to provide structural integrity during the photopolymerization process, while allowing a secondary chemistry to impart material property improvements. By using a porous microstructure generated through additive manufacturing, other reactive chemistries that do not necessarily have to form vinyl networks can be utilized by entrapping the reagents within the porous microstructure through the use of surface tension and viscosity. The infused microstructure can then be further cured to generate a second polymer network with a wide range of material properties. The second polymer network can be covalently bonded to the first polymer network, or simply entrapped within its scaffold structure.

Some vat-based photopolymerization techniques, such as top-down printing configurations, have long material turnover times due to the amount of photopolymer resin needed to fill the build volume, which limits the variety of reactive chemistries that can be used to produce additively manufactured articles. Here, the submersion module and the secondary chemistry contained within, can be cooled (provided the surface tension and viscosity at lowered temperatures is sufficiently low to flow into the porous microstructure). The cooling can slow potential chemical reactions from progressing, thereby extending the pot life of any reactive chemistry used in the submersion module.

In some cases, the submersion module and the secondary chemistry contained within, can be heated (provided the surface tension and viscosity at raised temperatures is sufficiently low to flow into the porous microstructure). The heating can allow formulations that would otherwise be too viscous, to infuse into the micro-structured lattice for further reaction.

Some top-down additive manufacturing machines utilize vats of liquid resin into which the build platform lowers upon the completion of each printed layer. Typically, such systems feature a recoating blade, that sweeps from one side of the vat to the other, to quickly level the resin surface in preparation for curing the next layer of the build. However, in a continuous additive manufacturing method, a recoating blade cannot be used to level the resin surface due to the continuous projection of actinic radiation which solidifies the liquid resin. This prevents the printing of large cross-sectional areas due to the slow speed of gravity-assisted resin reflow. Typically, only features with small cross-sectional areas can be printed with a continuous top-down additive manufacturing technique. Despite this apparent limitation, porous microstructures with small cross-sectional areas can be used as a mechanical scaffold to entrap a secondary chemistry. By submerging this scaffold into a secondary chemistry, an infused part can then be further reacted to form a part with an arbitrarily large cross-sectional area that can otherwise not be printed in a continuous fashion.

The systems and methods described herein can use reactive chemistries entrapped in a porous microstructure that is generated through additive manufacturing (also termed 3D printing). These methods can allow for the production of finished parts with tunable bulk density and material properties. Also described herein is a method of manufacturing, in a continuous process, a finished composite article which is at least partially manufactured using an additive manufacturing process.

Through the use of different reactive chemistries, a plurality of material functionalities and properties can be achieved. In some cases, a true composite article can be obtained by infusing a second polymer into the pores of a 3D printed scaffold.

Dual reactive constituents, such as ethylenically unsaturated monomers/oligomers bearing hydroxy, epoxy, amine, isocyanate, silyl hydride, carboxylic acid, or other active hydrogen, when present in the formulation used for the photopolymerized scaffold, can also act as adhesion promoters between the scaffold and entrapped resin through reaction between the functionalized scaffold surface and unreacted constituents in the entrapped resin.

An additively manufactured (3D printed) part can be coated with a secondary chemistry capable of undergoing further reaction either through thermal curing or by exposure to actinic radiation. The additively manufactured part can be cured from a first chemistry through exposure to actinic radiation. The first chemistry can contain a dual reactive monomer, comprising an ethylenically unsaturated moicty such as vinyl, acrylate, methacrylate along with a functional group, or plurality of functional groups, capable of reacting with constituents in the secondary chemistry to promote interfacial adhesion between the additively manufactured surface and the cured secondary chemistry.

A secondary chemistry can become entrapped (e.g., through the combination of viscosity and surface tension) between two or more additively manufactured surfaces which may be functionalized with a chemical moiety capable of reacting with constituents of the entrapped resin. The infused microstructure can then be further reacted to form a fully cured part with composite properties.

Control of resin surface tension and viscosity can enable the resin to penetrate into porous structures and become entrapped into a scaffold material. Surface tension and viscosity can be adjusted through the inclusion of surfactants, thickening agents, thixotropic agents, and fillers. Temperature can also be used to adjust surface tension and viscosity. Usc of higher temperature can be used, for example, to decrease surface tension and viscosity to allow for scaffold impregnation. Subsequently, temperature can be reduced to increase surface tension and viscosity to promote entrapment in a porous microstructure.

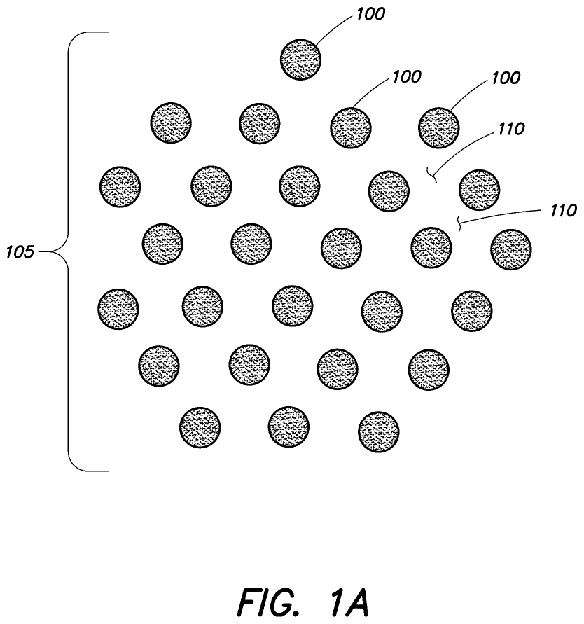

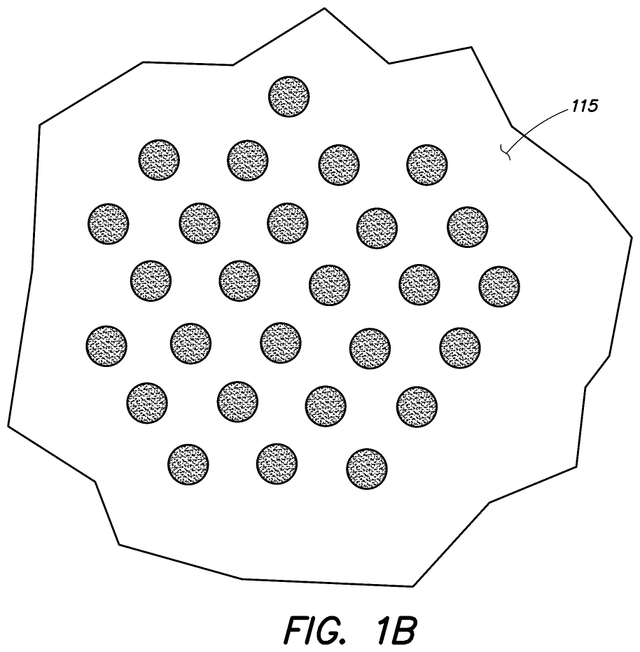

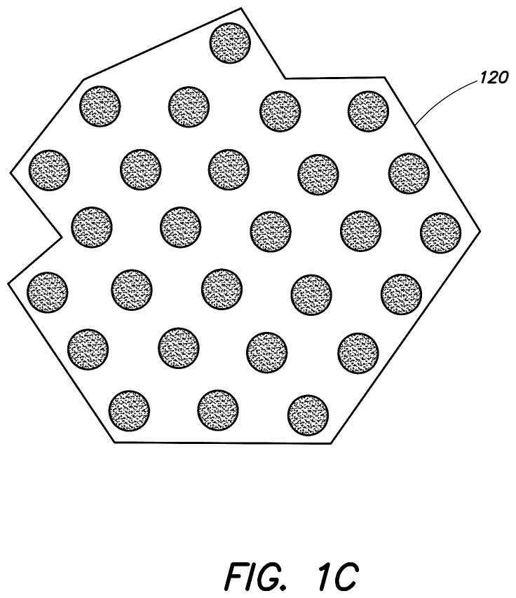

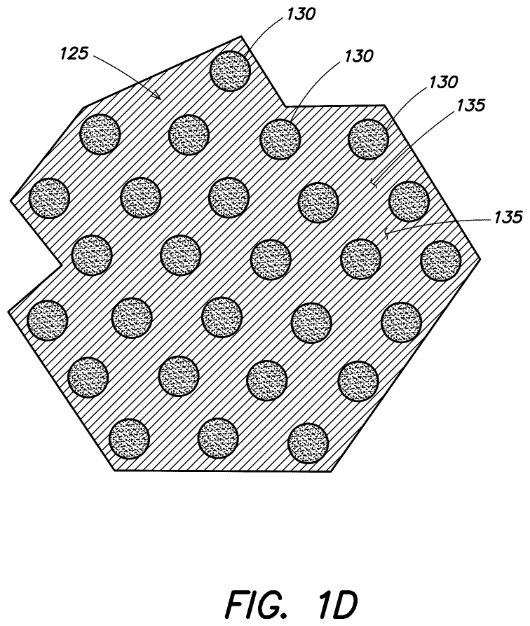

With reference to the FIG. 1A, a 3D printed scaffold can be printed or provided. The scaffold can be 3D printed on a pliable substrate. The pliable substrate can be moved through a vat of fluid that is polymerizable upon exposure to actinic radiation. Here, a cross-sectional schematic is shown where polymeric segments 100 are interconnected and form a porous volume 105 having pores 110. The surface of the scaffold can be associated with the boundary of the desired shape. The desired shape can be an entire article or a portion thereof (e.g., a handle of a swab which also has a bulb portion).

With reference to FIG. 1B, the scaffold can be contacted with a polymeric precursor 115 (e.g., including monomers and/or oligomers). The polymeric precursor can flow into and be retained in the porous volume of the scaffold. The contacting can be accomplished by immersing the scaffold in the polymeric precursor. In some cases, excess polymeric precursor can be removed (e.g., by washing). FIG. 1C shows that some polymeric precursor is retained in the porous volume. The exterior of the porous volume 120 can define a desired shape of the finished article to be produced.

With reference to FIG. 1D, the method described herein can further comprise polymerizing 125 the polymeric precursor that is retained in the porous volume. The result of the systems and methods can result in a polymeric object that has a polymeric scaffold comprising segments of a vinyl polymer 130 which are interconnected at an average distance between about 50 and about 1,000 micrometers. The polymeric object can also have a polymeric material 135 between the segments of vinyl polymer of the polymeric network.

The polymeric scaffold can be 3D-printed. It can be printed by projecting radiation down onto an open surface of a resin having a photo-initiator and polymerizable monomers. Portions of resin exposed to radiation can polymerize to form a scaffold. In some cases, excess resin can be rinsed from the scaffold. At this stage, the scaffold can be a partially cured “green” part. The porous scaffold can be further cured to produce a scaffold suitable for cross coating (i.e., filling with a second polymer as described herein).

The polymeric material can be in contact with the segments of vinyl polymer of the polymeric scaffold. In some cases, the polymeric material can be covalently bound to the segments of vinyl polymer of the polymeric scaffold.

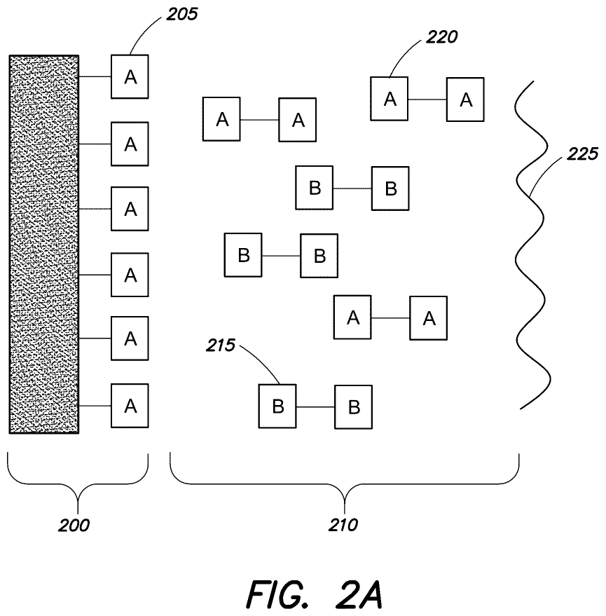

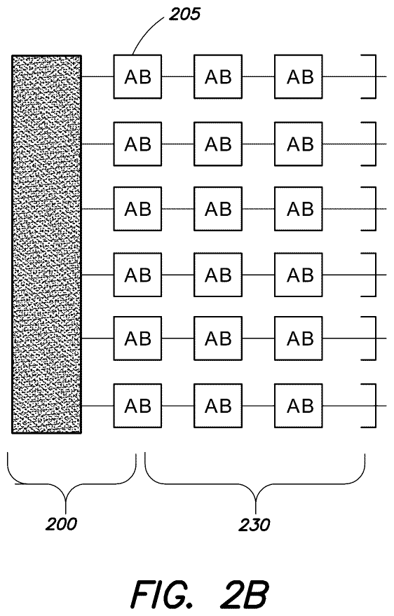

With reference to FIG. 2A, the scaffold 200 can have a first reactive chemical group exposed on its surface 205. The scaffold can be contacted with a polymeric precursor 210 having a plurality of functional groups. Some of the functional groups in the polymeric precursor are second functional groups 215 that react with the first functional groups (i.e., either on the surface of the scaffold 205 or in monomers of the polymeric precursor 220). In this case, an exterior surface of the scaffold is shown such that the far side of the polymeric precursor is exposed to air 225. Following polymerization of the polymeric precursor, FIG. 2B shows the scaffold 200 covalently bonded to the polymeric material 230.

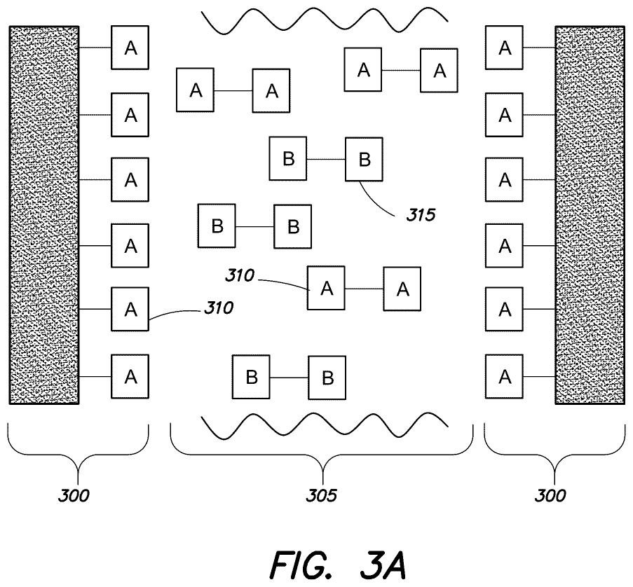

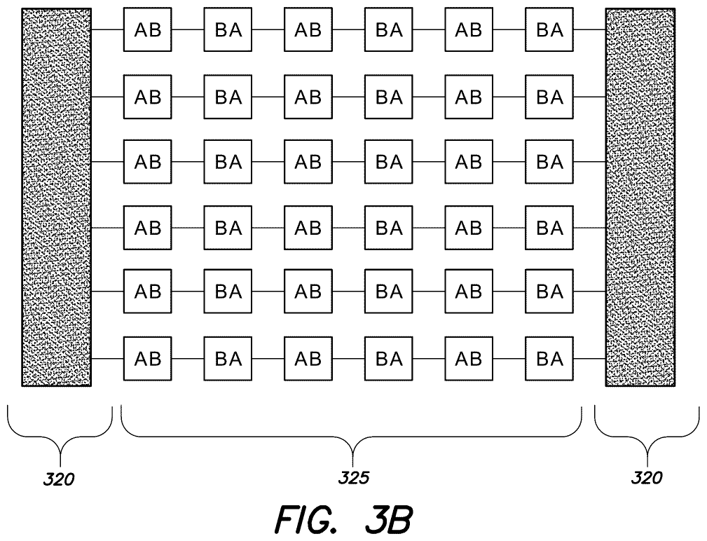

A similar chemistry can be performed within the pores of a 3D printed porous scaffold. With reference to FIG. 3A, opposing surfaces 300 of a pore can define a volume that can be filled with a polymeric precursor 305. The first reactive groups 310 on the surface of the scaffold and/or in the polymeric precursor can react with the second reactive groups 315 in the polymeric precursor. FIG. 3B shows the polymeric object having interconnected segments of vinyl polymer 320 defining a porous scaffold that is filled with a polymeric material 325. The non-homogenous composite polymeric object can have desirable properties including a high bulk density from a 3D printed part. The object can be non-homogenous because it includes two or more polymeric materials that are intertwined but not mixed on a molecular scale. The polymeric scaffold can at least partially surround the polymeric material.

In some cases, the polymeric object has an anisotropic property. The anisotropic property can be the Young's modulus, thermal conductivity, electrical conductivity, or any combination thereof.

The pore diameter (also referred to here as a distance at which the segments of polymer are connected in the scaffold) can be any diameter at which the polymer precursor is retained in the porous volume. In some cases, the pore diameter is a function of a viscosity of the polymer precursor and/or a surface tension between the polymer precursor and the 3D printed scaffold. In some embodiments, the pore diameter is about 50, about 100, about 200, about 300, about 400, about 500, about 600, about 700, about 800, about 900, or about 1,000 micrometers. In some embodiments, the pore diameter is at least about 50, at least about 100, at least about 200, at least about 300, at least about 400, at least about 500, at least about 600, at least about 700, at least about 800, at least about 900, or at least about 1,000 micrometers.

The pore diameter of the porous volume can be selected such that the polymeric precursor is retained in the porous volume. The viscosity of the polymeric precursor can be selected such that the polymeric precursor is retained in the porous volume. The polymeric precursor can be selected such that the polymeric precursor has a suitable surface tension to be retained in the porous volume. The viscosity of the polymeric precursor can be between about 500 and about 10,000 centipoise. In some cases, the viscosity of the polymeric precursor is about 5, about 7.5, about 10, about 20, about 30, about 40, about 50, about 60, about 70, about 80, about 90, or about 100 poise. In some instances, the viscosity of the polymeric precursor is at least about 5, at least about 7.5, at least about 10, at least about 20, at least about 30, at least about 40, at least about 50, at least about 60, at least about 70, at least about 80, at least about 90, or at least about 100 poise.

Retention of the polymer precursor can also be controlled by varying the pore size of the polymeric scaffolding. In some cases, the boundary shape can be populated with repeating units comprising strut elements, resulting in a uniform distribution of pore size in the region. In other cases, e.g., via computational design method such as described in U.S. patent application Ser. No. 17/211,603, which is hereby incorporated by reference in its entirety, the boundary shape can be populated by units with a gradation of pore size. The distribution of pore size can be related to the distribution of capillary action.

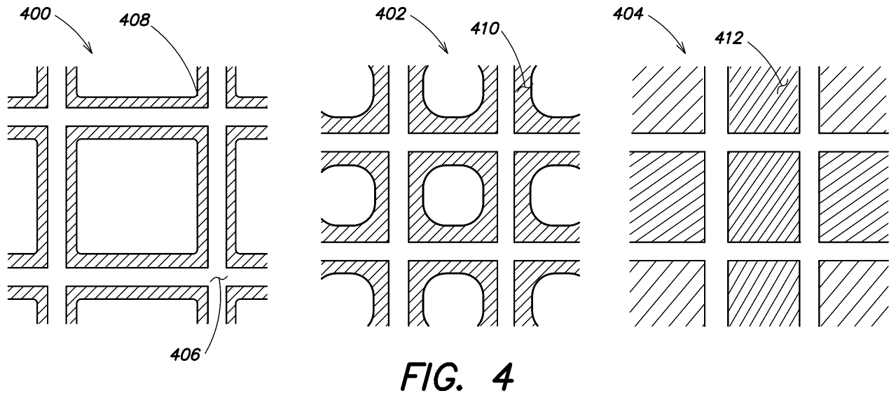

Several modes of fluid retention can be achieved by various levels of capillary action. FIG. 4 shows an example of how the dimensions of the interstitial spaces between portions of the scaffold affect coating versus in-filling of the scaffold with the polymeric material. The pore diameter (i.e., interstitial space) is reduced from a larger distance 400, to an intermediate distance 402, followed by a smaller distance 404. When the pore size is larger, a film 406 forms on the surface of the scaffold 408 (which can be polymerized and/or bound to the scaffold). Here, excessive precursor can be drained out from the unit. At intermediate pore sizes, capillary bridges or meniscus 410 can form between pore surfaces. Finally, at smaller pore sizes, complete infilling 412 of interstitial pore space can be achieved. Each of these modes corresponds to different magnitude of polymer precursor retention.

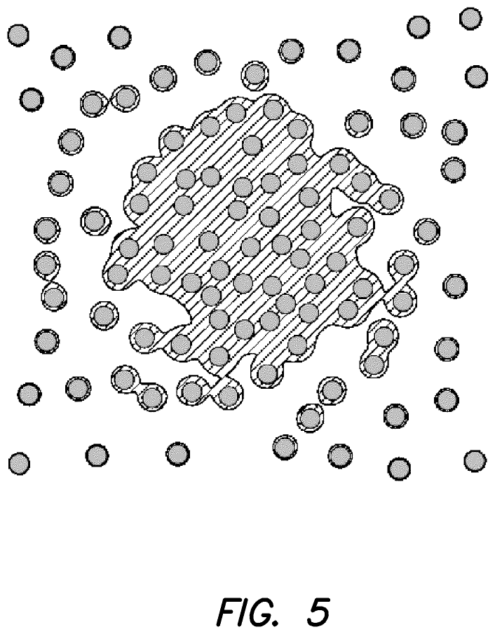

These effects can be incorporated into the design of the scaffold itself, where various portions of the scaffold have different distances between adjacent parts of the scaffold. For example, FIG. 5 shows an example of a complex scaffold having portions that are coated with polymeric material and portions that are filled in with polymeric material.

The distribution of pore size can correspond to distribution of concentration of polymer precursor within the boundary shape, implying a variable ratio between 3D printed scaffold and the entrained polymeric material. This can provide control over the mechanical performance of the final polymeric object by tailoring distribution of the two materials. This distribution can be controlled by computation method such as voxelization of converging field lines, or recursive subdivision of a voxel grid.

The polymeric object can have a desired bulk density. The methods described herein can start with a 3D printed porous scaffold having a low bulk density, where such a scaffold is easier and/or faster to print than a solid object lacking pores. The bulk density of the object can be increased to a desirable level by curing a polymeric precursor to form a polymeric material within the pores of the scaffold. In some cases, the bulk density of the polymeric object is about 0.7, about 0.75, about 0.8, about 0.85, about 0.9, about 0.95, about 1.0, about 1.05, about 1.1, about 1.15, or about 2.0 g/cm³. In some instances, the bulk density of the polymeric object is at least about 0.7, at least about 0.75, at least about 0.8, at least about 0.85, at least about 0.9, at least about 0.95, at least about 1.0, at least about 1.05, at least about 1.1, at least about 1.15, or at least about 2.0 g/cm³.

The systems and methods described herein can be performed with a variety of polymer systems. The scaffold can be made from a monomer having a plurality of ethylenically unsaturated moieties. The scaffold can be made from a monomer having at least two reactive groups. The reactive groups can be an ethynically unsaturated group and one or more of a hydroxy, epoxy, amine, isocyanate, silyl hydride, or carboxylic acid moiety.

The porous volume can have an arbitrarily large cross section. In some cases, the porous volume has a cross section of at least about 1, at least about 5, at least about 10, at least about 50, or at least about 100 centimeters (cm).

The polymeric material that fills in the scaffold can also be varied. In some cases, it comprises a thermoset polymer. The polymeric material can be a polyurethane, or an epoxy, for example. In some instances, the polymeric precursor does not comprise monomers that form a vinyl network.

The polymeric precursor can be capable of undergoing a free radical polymerization, polyaddition, or polycondensation reaction. The polymeric precursor can have at least one group capable of undergoing free radical polymerization.

The polymeric precursor can comprise at least two reactive chemical groups capable of undergoing a polycondensation reaction. The reactive chemical groups capable of undergoing polycondensation can comprise amine, epoxy, isocyanate, or any combination thereof.

The reactive chemical groups comprise a reactive pair selected from isocyanate/amine, isocyanate/hydroxyl, isocyanate/carboxylic acid, epoxy/amine, epoxy/hydroxyl, epoxy/carboxylic acid, oxetane/amine, anhydride/amine, anhydride/hydroxyl, amine/carboxylic acid, amine/ester, hydroxyl/carboxylic acid, hydroxyl/acid chloride, amine/acid chloride, or any combination thereof.

The polymeric precursor can be an aqueous or organic dispersion. The aqueous or organic dispersion can be functional polyurethane or monomer/oligomers to form polyurethane/polyurea.

In some cases, the polymeric precursor includes at least two monomers, where a first monomer has at least two copies of a first reactive group, a second monomer has at least two copies of a second reactive group, and the first reactive group is capable of forming a covalent bond with the second reactive group. In some cases, at least one of the reactive chemical groups is capable of forming a covalent bond with the scaffold.

The polymeric precursor can include other components such as a surfactant, thickening agent, thixotropic agent, or filler. The concentration of a surfactant, thickening agent, thixotropic agent, or filler can be selected such that the polymeric precursor is retained in the porous volume.

Temperature can be varied according to the methods described herein. For example, the polymeric precursor can be heated to a temperature sufficient for the polymeric precursor to flow into the porous volume. The polymeric precursor can be cooled to a temperature sufficient for the polymeric precursor to be retained in the porous volume.

The polymeric precursor can be polymerized using any suitable means. For example, the polymeric precursor can be polymerized upon exposure to heat or actinic radiation.

The systems, methods and materials described herein can have certain advantages over prior methods. In some cases, the present methods allow one to separate photopolymerizable chemistry used for generating 3D structure from secondary chemistry responsible for material performance. This can result in true composite behavior of the finished part. An ability to heat the photopolymerization module vat to promote fabrication of higher glass transition (Tg) in the green part allows printing of higher viscosity resins. Furthermore, the ability to heat or cool the second chemistry to adjust surface tension and/or viscosity can increase entrapment within the porous 3D printed microstructure. The methods described herein can allow one to manufacture objects of arbitrary bulk density through a combination of printing and infusion. The objects can have anisotropic material performance by varying underlying 3D printed microstructured lattice, e.g., through computational design. Dual reactive chemicals can increase adhesion and material performance between the 3D printed scaffold and the infused secondary chemistry. The modular nature of the systems and methods described herein can allow one to swap out processing modules in a production line in order to accommodate different secondary chemistries. In some cases, 3D objects can be manufactured in a continuous manner, e.g., without the need for manual labor.

Also, it should be appreciated that one or more 3D printing systems may be used to implement the methods described herein. These can include a proprietary or commercially available 3D printer (e.g., a DLP printer). The printer can direct UV radiation through a transparent window to contact the photo-curable resin described herein.

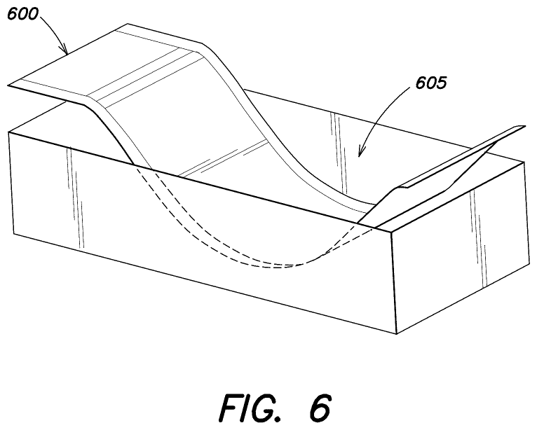

In some cases, the UV radiation can be directed to an exposed surface of a volume of resin (i.e., printed top-down). FIG. 6 shows an example of a system where a pliable substrate 600 is moved through a vat of resin 605. UV radiation can be directed at the resin in proximity to where the sheet enters the resin, where the sheet is at a consistent angle (e.g., about 45°) with respect to the resin surface. The sheet can be moved forward following printing of a layer of the article, at which point additional resin can flow over the printed arca (i.e., rccoating), allowing printing of another layer. The process can be repeated to form the printed article. The printed article can be washed of non-cured resin and subjected to a second (e.g., thermal) curing step as described herein. For example, some embodiments may be used in conjunction with one or more systems described in U.S. patent application Ser. No. 17/668,503, filed Feb. 10, 2022, incorporated herein in its entirety. However, it should be appreciated that other printer methods and systems may be used with embodiments as described herein.

The geometry of the article to be printed can be digitally represented in any suitable file structure (e.g., for use in controlling the 3D printer). Such systems can include slicing the geometry into a plurality of layers, e.g., as described in U.S. patent application Ser. No. 17/211,603, filed Mar. 24, 2021, incorporated herein in its entirety. Such systems, methods, and file formats can be suitable for printing microstructures.

The above-described embodiments can be implemented in any of numerous ways. For example, the embodiments may be implemented using hardware, software or a combination thereof. When implemented in software, the software code can be executed on any suitable processor or collection of processors, whether provided in a single computer or distributed among multiple computers. It should be appreciated that any component or collection of components that perform the functions described above can be generically considered as one or more controllers that control the above-discussed functions. The one or more controllers can be implemented in numerous ways, such as with dedicated hardware or with one or more processors programmed using microcode or software to perform the functions recited above.

In this respect, it should be appreciated that one implementation of the embodiments of the present invention comprises at least one non-transitory computer-readable storage medium (e.g., a computer memory, a portable memory, a compact disk, etc.) encoded with a computer program (i.e., a plurality of instructions), which, when executed on a processor, performs the above-discussed functions of the embodiments of the present invention. The computer-readable storage medium can be transportable such that the program stored thereon can be loaded onto any computer resource to implement the aspects of the present invention discussed herein. In addition, it should be appreciated that the reference to a computer program which, when executed, performs the above-discussed functions, is not limited to an application program running on a host computer. Rather, the term computer program is used herein in a generic sense to reference any type of computer code (e.g., software or microcode) that can be employed to program a processor to implement the above-discussed aspects of the present invention.

### EXAMPLES

### Example 1: Production and Tensile Testing of Cross-Coated Lattices

Lattices were printed using a photo-curable resin and top-down 3D printer on a pliable substrate. The lattice has dimensions of 0.82 millimeters (mm) per unit cell and a strut diameter of 0.2 mm.

The lattices were placed into different groups with at least 8 samples in each group. One group was used as the control group without the additional cross coating treatment. Two test groups were treated in the corresponding solution A for 30 seconds, then in solution B for 30 seconds. The process was repeated for additional 7 cycles. Afterward, the treated lattices were purged with air to remove residual solvents, then baked in an oven at 60 ° C.for 2 hours.

| Group Name | Solution A | Solution B |
|---|---|---|
| Gelest DMS-A21 | DMS-A21 in Hexane | MDI in Xylene |
| Siltech Silmer ® Di-50 | Di-50 in Cyclohexane | MDI in Propylene |
| | | Carbonate |

The lattices from the different groups were used for tensile testing on a Test Resources tensile tester using ASTM D638 protocols. The cross-coated lattices showed about a 22% reduction in ultimate tensile strength (UTS), about a 41% reduction in Young's Modulus, and about a 54% increase in elongation at break compared with the untreated lattices.

Various aspects of the present invention may be used alone, in combination, or in a variety of arrangements not specifically discussed in the embodiments described in the foregoing and are therefore not limited in their application to the details and arrangement of components set forth in the foregoing description or illustrated in the drawings. For example, aspects described in one embodiment may be combined in any manner with aspects described in other embodiments.

Also, embodiments of the invention may be implemented as one or more methods, of which an example has been provided. The acts performed as part of the method(s) may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting. The invention is limited only as defined by the following claims and the equivalents thereto.

1. A method for forming a polymeric object, comprising:
a. providing a 3D-printed scaffold having a porous volume, wherein a surface of the scaffold is associated with a boundary of a desired shape;
b. contacting the scaffold with a polymeric precursor such that the polymeric precursor flows into and is retained in the porous volume of the scaffold; and
c. polymerizing the polymeric precursor that is retained in the porous volume.

2. The method of claim 1, wherein the porous volume is a 3D-printed lattice.

3. The method of claim 1, wherein the porous volume has a pore diameter between about 50 and about 1,000 micrometers.

4. The method of claim 1, wherein a pore diameter of the porous volume is selected such that the polymeric precursor is retained in the porous volume.

5. The method of claim 1, wherein a viscosity of the polymeric precursor is selected such that the polymeric precursor is retained in the porous volume.

6. (canceled)

7. The method of claim 1, wherein a composition of the polymeric precursor is selected such that the polymeric precursor has a suitable surface tension to be retained in the porous volume.

8. The method of claim 1, further comprising washing the polymeric precursor from the scaffold prior to polymerizing the polymeric precursor that is retained in the porous volume.

9. The method of claim 1, wherein the polymerized polymeric precursor forms covalent bonds with the scaffold.

10. The method of claim 1, wherein the polymerized polymeric precursor effectively fills the porous volume.

11. The method of claim 1, wherein contacting the scaffold with a polymeric precursor comprises submersing the scaffold in the polymeric precursor.

12. The method of claim 1, wherein a surface of the scaffold is functionalized to react with the polymeric precursor.

13. The method of claim 1, wherein the scaffold is made from a monomer having a plurality of ethylenically unsaturated moieties.

14. The method of claim 1, wherein the scaffold is made from a monomer having at least two reactive groups.

15. The method of claim 14, wherein the reactive groups are an ethynically unsaturated group and one or more of a hydroxy, epoxy, amine, isocyanate, silyl hydride, or carboxylic acid moiety.

16. (canceled)

17. The method of claim 1, wherein the polymeric precursor is capable of undergoing a free radical polymerization, polyaddition, or polycondensation reaction.

18-20. (canceled)

21. The method of claim 1, wherein the polymeric precursor comprises reactive chemical groups comprise comprising a reactive pair selected from Isocyanate/amine, isocyanate/hydroxyl, isocyanate/carboxylic acid, epoxy/amine, epoxy/hydroxyl, epoxy/carboxylic acid, oxetane/amine, anhydride/amine, anhydride/hydroxyl, amine/carboxylic acid, amine/ester, hydroxyl/carboxylic acid, hydroxyl/acid chloride, amine/acid chloride, or any combination thereof.

22-23. (canceled)

24. The method of claim 1, wherein the polymeric precursor comprises at least two monomers, wherein a first monomer comprises at least two copies of a first reactive group, a second monomer comprises at least two copies of a second reactive group, and the first reactive group is capable of forming a covalent bond with the second reactive group.

25-27. (canceled)

28. The method of claim 1, wherein the polymeric precursor does not comprise monomers that form a vinyl network. 29-33. (canceled)

34. The method of claim 1, wherein the scaffold is 3D printed on a pliable substrate.

35. (canceled)

36. A polymeric object, comprising:
a. a polymeric scaffold comprising segments of a vinyl polymer which are interconnected at an average distance between about 50 and about 1,000 micrometers; and
b. a polymeric material between the segments of vinyl polymer of the polymeric network.

37-46. (canceled)
